(19) United States
(12) Patent Application Publication
(10) Pub. No.: US 2009/0119982 A1
(43) Pub. Date: May 14, 2009

(54) SYSTEM FOR GROWING PLANTS

(76) Inventors: Steven William GALLO, Montreal (CA); Amanda Besharah, Green Valley (CA)

Correspondence Address: DANIEL B. SCHEIN, PH.D., ESQ., INC., P. O. BOX 68128, Virginia Beach, VA, 23471, US

(21) Appl. No.: 11/939,558

(22) Filed: Nov. 14, 2007

(51) Int. Cl. A01G 25/02; A01G 13/02

(52) U.S. Cl. 47/21.1; 47/20.1

(57) ABSTRACT

The present invention relates to a device for covering a plant growing medium. The device includes a sheet and an aperture defined by the sheet. A first portion of the sheet surrounds the aperture. A second portion of the sheet has at least one ledge for engaging a top surface of the plant growing medium. The second portion of the sheet is integrated with the first portion of the sheet such that the at least one ledge is situated at a height below the height of the first portion of the sheet.

### FIELD OF INVENTION

The present invention relates to a system for growing plants.

### BACKGROUND OF INVENTION

There are a number of situations in which it may be desirable to cultivate plants without having to use soil. For example, during the colder months of the year, some gardeners begin growing seedlings indoors in anticipation of spring. This process is more simple and sanitary when soil is not used. Alternatively, nutrientrich soil may not be available.

Growing mediums other than soil may be used to germinate seeds. One popular growing medium is rockwool. Rockwool is used extensively for hydroponic growing systems. Rockwool is made by melting a combination of rock and sand and spinning the resulting mixture. This process produces fibres that may be formed into different shapes and sizes.

Rockwool absorbs and maintains water and other liquids. Further, rockwool is porous and thus retains oxygen. As a result, plants that grow in rockwool have healthy root systems. Finally, rockwool can be formed into a number of shapes and sizes. Frequently, rockwool fibres are compressed into cubes or blocks.

Rockwool cubes and blocks are manufactured in different sizes. Most commonly, the sides of the cubes are three inches, four inches or six inches long. If a plant has grown such that the rockwool cube has met its capacity, a larger cube can be hollowed out so that the smaller cube may be inserted into the larger cube, thus permitting further propagation of the plant's root system.

Before using a rockwool cube, the cube must be treated by soaking it in a nutrient solution to adjust its pH level. Further, once seeds or seedlings are placed in rockwool, the rockwool is periodically moistened. Therefore, rockwool is moist when in use.

The moisture of rockwool cubes creates some difficulties for user. Specifically, when rockwool is exposed to the light that is normally used for indoor germination and cultivation of plants or sunlight in a greenhouse setting, algae forms on the surface of the moist rockwool cubes. Such algae attracts insects such as fungus gnats and shoreflies. Further, when algae decays and dies, it can become detrimental to plants since it may invite bacteria and viruses. Algae can even compete with the plants being grown for oxygen, which is necessary for nutrient uptake.

Covering rockwool also inhibits the evaporation of moisture that has been absorbed by the rockwool cube. Accordingly, covering a rockwool cube and protecting it from direct light ultimately conserves water.

To prevent the growth of algae on rockwool, it is necessary to deprive the algae of light. Algae flourishes in wet, well lit locations and depriving it of light prevents photosynthesis.

Various solutions have been proposed for covering rockwool cubes. However, previously disclosed rockwool cube covers suffer from a number of disadvantages. First, such covers limit the circulation of oxygen, thus creating an anaerobic environment. This inhibits nutrient uptake by the plant. Further, some previously disclosed cube covers are simply sheets of plastic that are placed above the cube and frequently engage the surface of the cube, thus further inhibiting the circulation of oxygen. Finally, previously disclosed covers for plant growing mediums cannot be placed over a plant growing from the plant growing medium without damaging the plant.

Rockwool cubes are frequently used as an irrigation component for a plant growing system. Such systems incorporate a means for delivering moisture (normally a nutrient solution) to the rockwool cubes. Most frequently, a series of hoses delivers the nutrient solution from a reservoir to one or more drip stakes inserted into the rockwool cube. A hose engages the drip stake such that the nutrient solution from the hose trickles down the stake and is absorbed by the rockwool cube. Multiple drip stakes and hoses may be used for each rockwool cube to better disperse the nutrient solution. Each drip stake moors a hose in place to prevent the nutrient solution from leaking outside of the irrigation system.

The circumference of the hose that delivers the nutrient solution can vary depending upon the amount of moisture required. The circumference of the hose should be large enough such that the hose can engage the drip stake so that the hose is held in place.

There are a number of drawbacks to using the hose and drip stake system for delivering nutrient solutions to rockwool cubes or bricks. Such a system does not result in the efficient dispersal of nutrient solution to the rockwool and accordingly the root system does not receive an even distribution of moisture. Adding extra drip stakes and hoses adds costs and complicates the plant growing system. Specifically, extra hoses results in greater potential for entanglement and a greater likelihood that a hose will become disengaged from its corresponding drip stake such that nutrient solution drips away from the rockwool cube.

Further, especially when more than one plant is being grown such that multiple rockwool cubes are required, the process of placing each hose to engage a corresponding drip stake is time consuming. This problem is exacerbated when multiple drip stakes are utilized for each rockwool cube.

### SUMMARY OF INVENTION

According to a first broad aspect of an embodiment of the present invention, there is disclosed a device for covering a plant growing medium comprising a sheet and an aperture defined by the sheet. The sheet has a first portion that surrounds the aperture and a second portion having at least one ledge engaging a top surface of the plant growing medium and integrated with the first portion of the sheet such that the at least one ledge is situated at a height below the first portion of the sheet.

According to a further broad aspect of an embodiment of the present invention, there is disclosed a device for use with a cover for a plant growing medium wherein the cover defines an aperture. The device comprises a reservoir for receiving liquid through at least one hole defined by the cover and a means for suspending the reservoir above the plant growing medium and below the cover. The device further comprises at least one opening defined by the reservoir wherein the at least one opening is in communication with the plant growing medium.

According to a further broad aspect of an embodiment of the present invention, there is disclosed a device for covering a plant growing medium comprising a sheet and an aperture defined by the sheet. The device further comprises a reservoir for receiving liquid through at least one hole defined by the sheet, the reservoir being attachable to the sheet such that the reservoir is suspended above the plant growing medium and below the sheet. The device further comprises at least one opening defined by the reservoir wherein the at least one opening is in communication with the plant growing medium.

According to a further broad aspect of the embodiment of the present invention, there is disclosed a device for engaging a hole in a cover for a plant growing medium, the device comprising an outlet portion for discharging water, the outlet portion having a bevelled exterior wall such that the outlet portion may be received by the hole. The device further comprises an inlet portion for receiving water from a hose inserted into the inlet portion wherein the inlet portion is separated from the outlet portion by a flange at an end of the outlet portion proximate to the inlet portion and the flange engages a portion of the cover surrounding the hole. The device further comprises an interior wall defining a channel through the device whereby the interior slopes such that the channel is wider at an end of the inlet portion distal from the outlet portion than at an end of the inlet portion proximate to the outlet portion. The device further comprises a plurality of threads projecting from the interior wall of the device such that one of the threads releasably secures the hose inserted into the inlet portion.

Descriptive references herein such as “planar”, “parallel”, “perpendicular”, “normal”, “straight”, “horizontal” or “vertical” are for convenience of description only. It will be appreciated by one skilled in the art that the placement of elements may depart moderately from a planar, parallel, perpendicular, normal, straight, horizontal or vertical configuration.

### BRIEF DESCRIPTION OF THE DRAWINGS

In drawings which illustrate by way of example only a preferred embodiment of the invention:

FIG. 1 is a perspective view of a top surface of a first embodiment of the device;

FIG. 2 is a perspective view of a bottom surface of a first embodiment of the device;

FIG. 3 is a sectional view of the first embodiment of the device along line 3-3 of FIG. 1 and set upon a plant growing medium;

FIG. 4 is a top perspective view of a front side of a second embodiment of the device in a closed orientation;

FIG. 5 is a top perspective view of a back side of the second embodiment of the device in a closed orientation;

FIG. 6 is a top perspective view of a front side of the second embodiment of the device in a partially open orientation and set upon a plant growing medium;

FIG. 7 is a top perspective view of a third embodiment of the device;

FIG. 8 is an exploded view of the third embodiment of the device set upon a plant growing medium and in use with the first embodiment of the device;

FIG. 9 is a top perspective view of a fourth embodiment of the device showing a cover, an attachment and two hoses attached to the cover all set upon a plant growing medium;

FIG. 10 is a bottom perspective view of the attachment;

FIG. 11 is a top perspective view of the attachment;

FIG. 12 is an exploded view of the fourth embodiment of the device in relation to a plant growing medium;

FIG. 13 is a plan view of the fourth embodiment of the device set upon a plant growing medium; and

FIG. 14 is a top perspective view of a fifth embodiment of the device.

### DETAILED DESCRIPTION OF THE PREFERRED EMBODIMENTS

The present invention will now be described for the purposes of illustration only in connection with certain embodiments. However, it is to be understood that other objects and advantages of the present invention will be made apparent by the following description of the drawings according to the present invention. While preferred embodiments are disclosed, this is not intended to be limiting. Rather, the general principles set forth herein are considered to be merely illustrative of the scope of the present invention and it is to be further understood that numerous changes may be made without straying from the scope of the present invention.

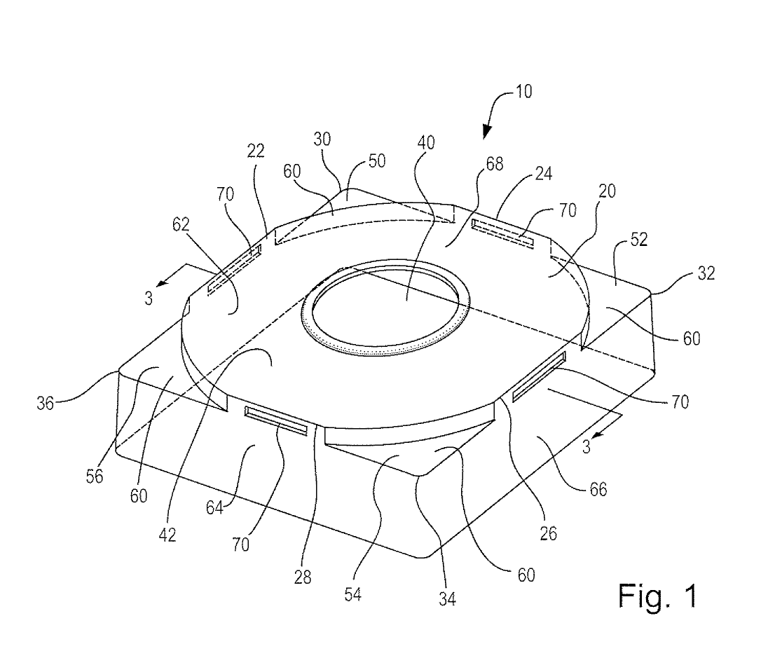

A cover 10 for a plant growing medium is shown in FIGS. 1 to 3. The cover 10 is constructed from a suitably rigid material such as plastic.

The cover 10 has a sheet 20. The sheet 20 may be of any shape or size so as to cover a surface of a plant growing medium that is directly exposed to light. In the embodiment shown in FIGS. 1 to 3, the sheet 20 is square. Preferably, the sheet is substantially planar. Further, the sheet 20 has four edges 22, 24, 26 and 28. The four edges 22, 24, 26 and 28 meet at four corners 30, 32, 34 and 36.

The sheet 20 defines an aperture 40. A first portion 42 of the sheet 20 surrounds the aperture 40. The aperture 40 may have any shape or size. In the embodiment shown in FIGS. 1 to 3, the aperture 40 is circular. The aperture 40 shown in FIGS. 1 to 3 is orientated at the centre of the sheet 20. It will be apparent to a person skilled in the art that it is not necessary for the aperture 40 to be orientated at the centre of the sheet 20. The aperture 40 may also be in a different position in the sheet 20 such as near one of the edges 22, 24, 26 or 28 of the sheet 20 or near one of the corners 30, 32, 34 or 36 of the sheet 20.

The sheet 20 has a second portion incorporating at least one ledge. In the embodiment shown in FIGS. 1 to 3, there are four ledges 50, 52, 54 and 56. It will be apparent to a person skilled in the art that the objects of the invention may be satisfied by incorporating any number of ledges and embodiments incorporating one or more ledges are contemplated.

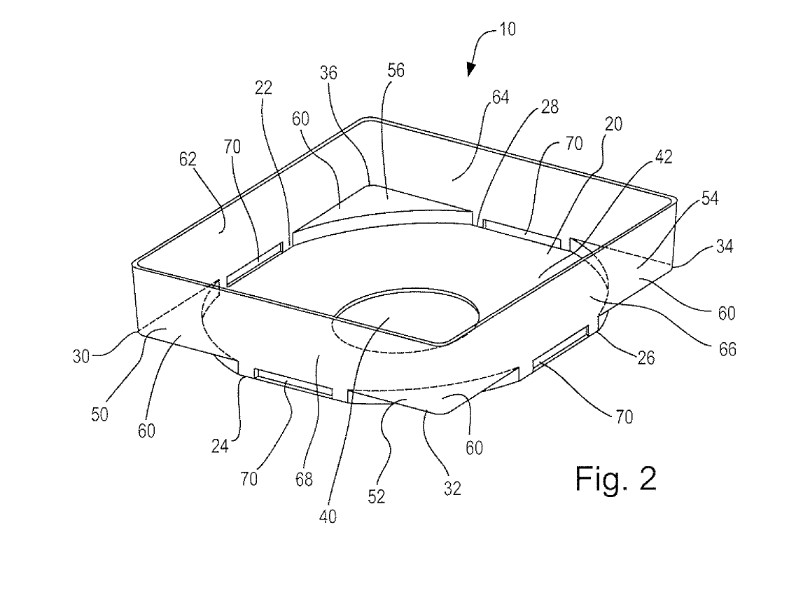

As seen in FIGS. 1 and 2, each of the ledges 50, 52, 54 and 56 is orientated at a second portion 60 of the sheet 20 proximate to one of the corners 30, 32, 34 or 36 of the sheet 20. Further, each of the ledges 50, 52, 54 and 56 is integrated with the first portion 42 of the sheet 20 surrounding the aperture 40. As seen in FIG. 1, each of the ledges 50, 52, 54 and 56 is orientated at a height below the height of the first portion 42 of the sheet 20 surrounding the aperture 40. In a preferred embodiment, each of the ledges 50, 52, 54 and 56 is in a plane parallel to the plane of the sheet 20.

As seen in FIGS. 1 to 3, in a preferred embodiment of the cover, four walls 62, 64, 66 and 68 are attachable to the sheet 20. In the embodiment shown in FIGS. 1 to 3, each of the walls 62, 64, 66 and 68 is slightly slanted and flares outward from the top of the wall to the bottom of the wall. In a preferred embodiment, each of the walls 62, 64, 66 and 68 opposes one of the other walls.

Each of the walls 62, 64, 66 and 68 define a slit 70. Each of the slits 70 is orientated above the height of the ledges 50, 52, 54 and 56. In the embodiment shown in FIGS. 1 to 3, each of the slits 70 is rectangular, though the objects of the invention may be achieved by providing the slits with an alternative shape.

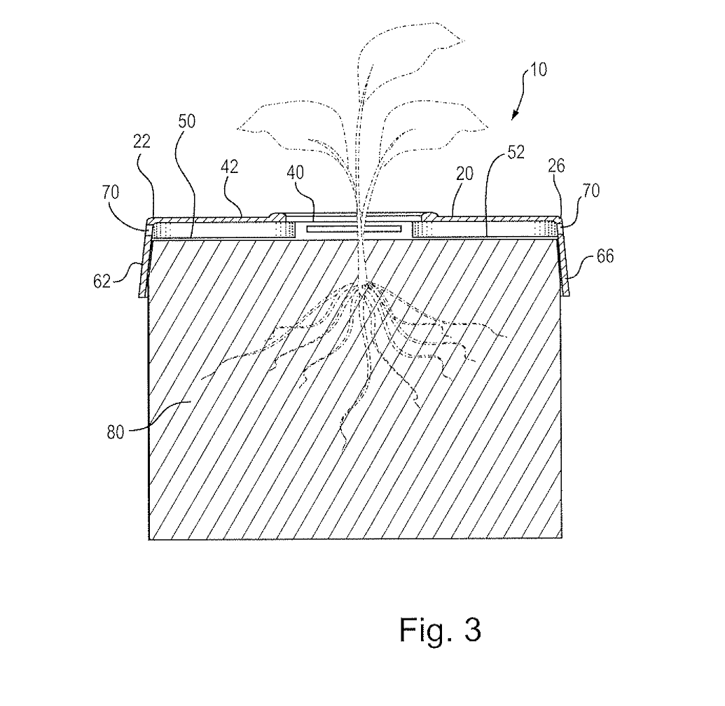

As seen in FIG. 3, in operation, the cover 10 is placed upon a plant growing medium 80. The plant growing medium 80 can be suitable for any medium for growing plants, including soil and rockwool. The shape and dimensions of the cover 10 must be such that the cover 10 fits on the plant growing medium 80 and each of the ledges 50, 52, 54 and 56 engages a top surface of the plant growing medium 80. Specifically, the distance between the sets of opposing walls distal from the sheet 20 must be greater than the distance between opposing walls of the plant growing medium. In the embodiment shown in FIG. 3, the plant growing medium is malleable such that a portion of each of the walls 62, 64, 66 and 68 of the cover 10 proximate to the sheet 20 engages the plant growing medium 80. The resulting friction between the cover 10 and the plant growing medium 80 holds the cover 10 upon the plant growing medium 80 in systems where the plant growing medium 80 is rotated.

When the cover 10 is placed on the plant growing medium 80, each of the ledges 62, 64, 66 and 68 engages a top surface of the plant growing medium 80 and thus prevents a user from pressing the cover 10 onto the plant growing medium 80 to a level where the slits are not above the top surface of the plant growing medium 80.

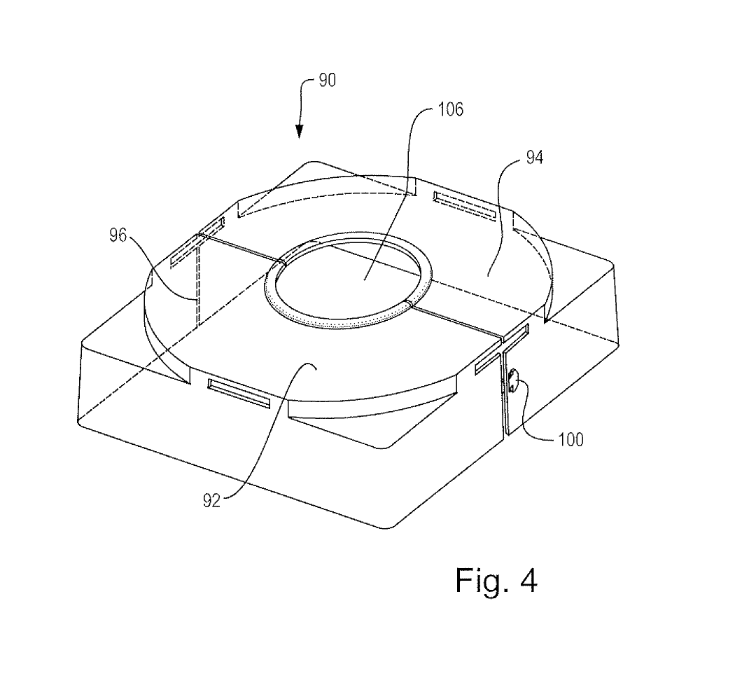

A further embodiment of the cover for a plant growing medium is shown in FIGS. 4 to 6. This embodiment of the cover 90 has two portions 92 and 94. It will be apparent to a person skilled in the art that the objects of the invention may be satisfied by dividing the cover into any number of portions greater than one and such embodiments are contemplated.

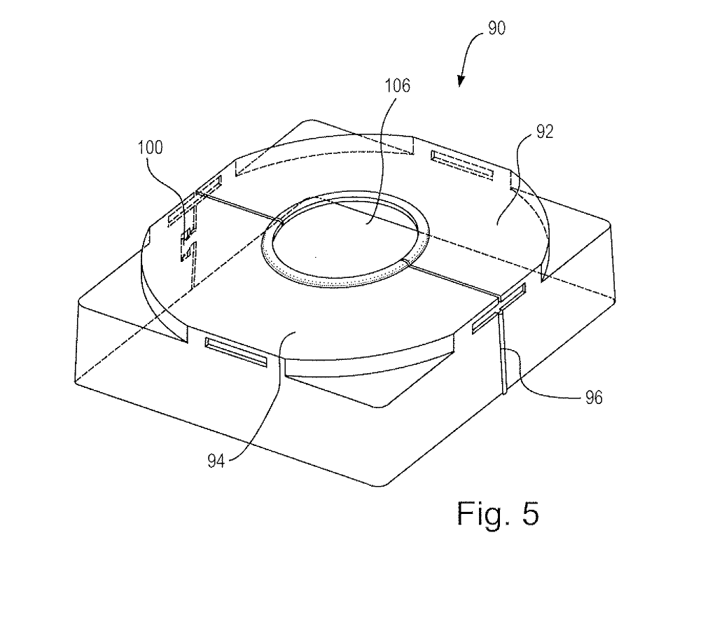

In the embodiment shown in FIGS. 4 to 6, a first portion 92 of the cover 90 is pivotably attached to a second portion 94 of the cover 90 by a hinge 96, as seen in FIG. 5. The hinge 96 is preferably constructed of a flexible material such as plastic. It will be apparent to a person skilled in the art that the objects of the invention may be achieved by incorporating any number of hinges to pivotably attach the first portion 92 and the second portion 94.

As seen in FIG. 4, this embodiment of the cover also incorporates a fastener 100 for releasably attaching the first portion 92 of the cover 90 to the second portion 94 of the cover 90. Any means for releasably attaching the first portion 92 of the cover 90 to the second portion 94 of the cover 90, including a buckle, a clasp, a clamp, a button and a hook is contemplated and will achieve the object of the invention.

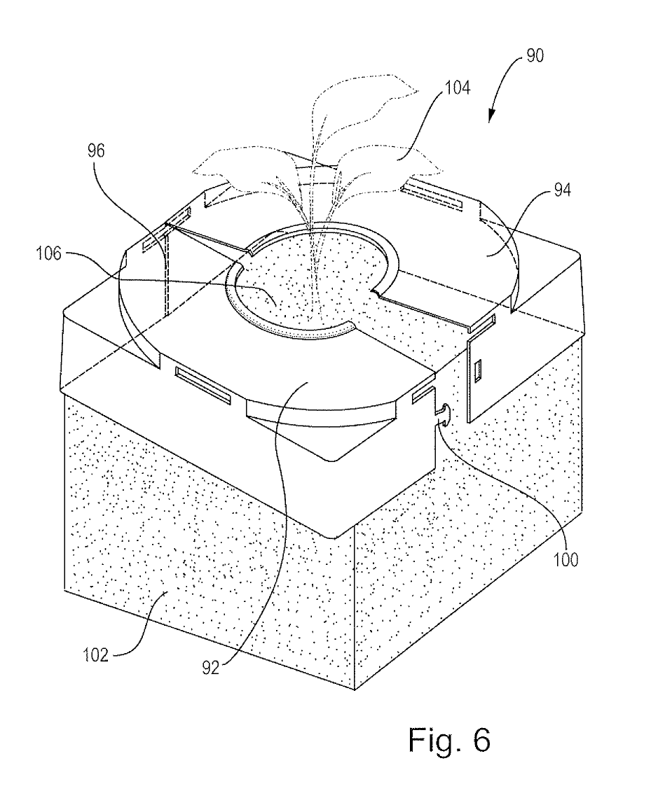

The cover 10 may be pivoted between a closed orientation, shown in FIGS. 4 and 5, and an open orientation. A partially open orientation is shown in FIG. 6. More specifically, when the cover 90 is in the closed orientation, a user unfastens the fastener 100 and applies pressure upon the first portion 92 of the cover 90 in one direction while applying pressure upon the second portion 94 of the cover 90 in an opposite direction so as to pivot the portions about the hinge 96. Thus before applying the cover 90 to a plant growing medium 102, the cover 90 is in the open position with the first portion 92 and the second portion 94 spread apart. Where a plant 104 is growing from the plant growing medium 102 the first portion 92 and the second portion 94 may be applied laterally from opposite directions and placed about the plant 104 so that an aperture 106 surrounds the stem of the plant 104. Accordingly, during the process of applying the cover 90 to the plant growing medium 102, the cover 90 does not engage the plant 104. Once the cover 90 has been applied as such, the fastener 100 can be fastened so as to secure the cover 90 upon the plant growing medium 102.

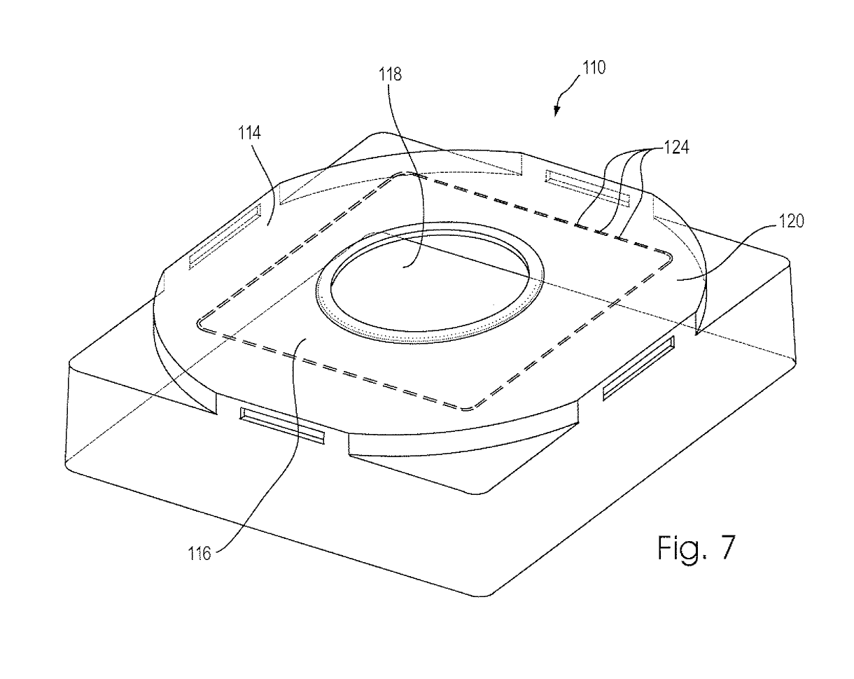

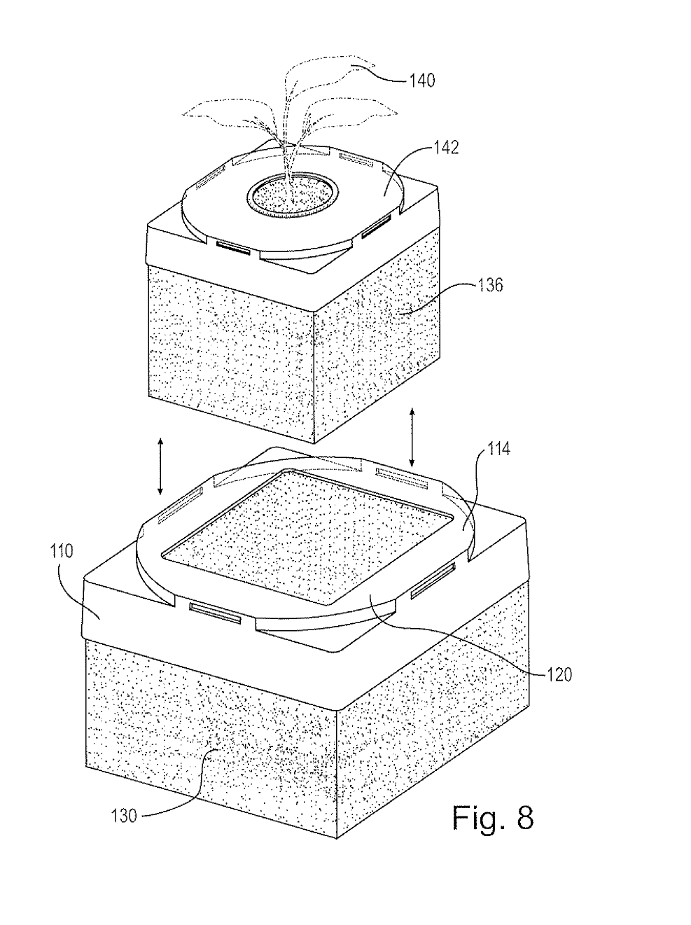

A further embodiment of the present invention is shown in FIGS. 7 and 8. In the embodiment of the cover 110 shown in FIG. 7, the sheet 114 has a first portion 116 surrounding an aperture 118. The first portion 116 is removably attachable to a second portion 120 of the sheet 114 surrounding the first portion 116 of the sheet 114. The embodiment of the invention shown in FIG. 7 incorporates a single removable portion. Any number of removable portions surrounding one another are contemplated.

There is a series of perforations 124 defined by the sheet 114 and orientated between the first portion 116 of the sheet 114 and second portion 120 of the sheet 114. In a preferred embodiment, the perforations 124 are large enough such that the first portion 116 of the sheet 114 can be easily removed from the second portion 120 of the sheet 114. Other means for removably attaching the portions of the sheet, including detachable fasteners such as velcro or clasps are contemplated.

As seen in FIG. 8, in operation, this embodiment of the cover 110 is used for a large plant growing medium 130 upon which a small plant growing medium 136 may be placed. Specifically, a plant 140 may grow in the small plant growing medium 136 to a size such that its root system has expanded to occupy most of the volume of the small plant growing medium 136. In such circumstances, the root system cannot expand further and further growth of the plant 140 is inhibited. To add further volume of plant growing medium, the small plant growing medium 136 is placed on top of the large plant growing medium 130. The root system may then expand within the large plant growing medium 130.

A cover of the embodiment shown in FIG. 7 may be used to ensure that a top surface of the portion of the large plant growing medium 130 remains covered when the small growing medium 136 is set upon the large growing medium 130. As seen in FIG. 8, the first portion 116 of the sheet 114 has been detached from the cover 110 such that the small plant growing medium 136 fits within the remaining portion of the larger cover 110. A top surface of the small plant growing medium 136 remains covered by a small cover 142. Accordingly, the top surfaces of the small plant growing medium 136 and a portion of the large plant growing medium 130 are both covered.

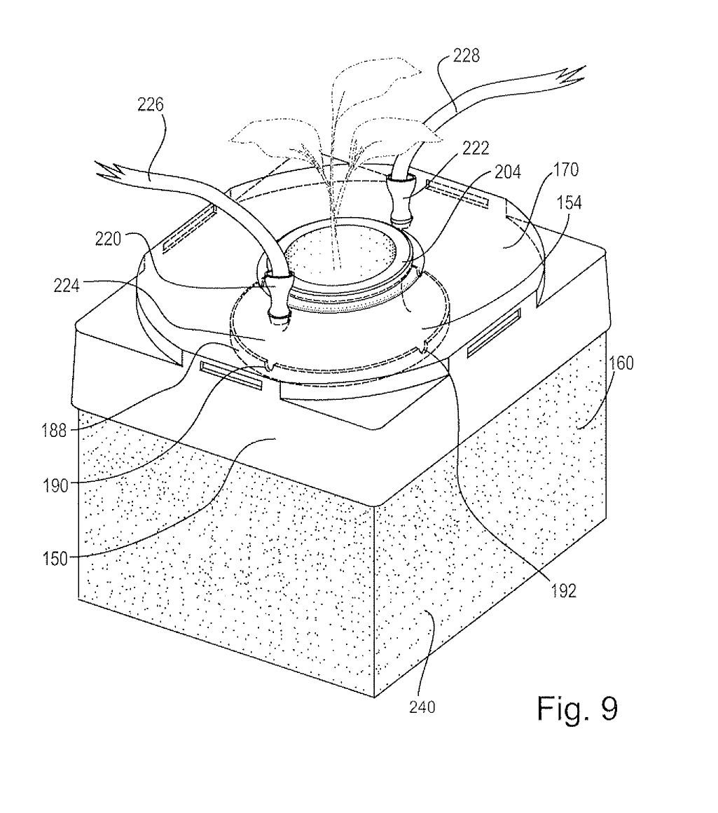

An attachment 150 for distributing liquid is shown in FIGS. 9 to 13. The attachment includes a reservoir 154 for receiving liquid. In operation, the reservoir 154 is suspended above a plant growing medium 160 and below a cover 170. The reservoir 154 may be suspended above the plant growing medium 160 and below the cover 170 by a number of means, including engagement with the plant growing medium 160 or the cover 170 or both.

In the embodiment shown in FIGS. 9 to 13, the reservoir 154 is suspended above the plant growing medium 160 by its attachment to a cylinder 180. In the embodiment shown, the reservoir 154 is integrally attached to the cylinder 180. The cylinder 180 defines a hollow 184.

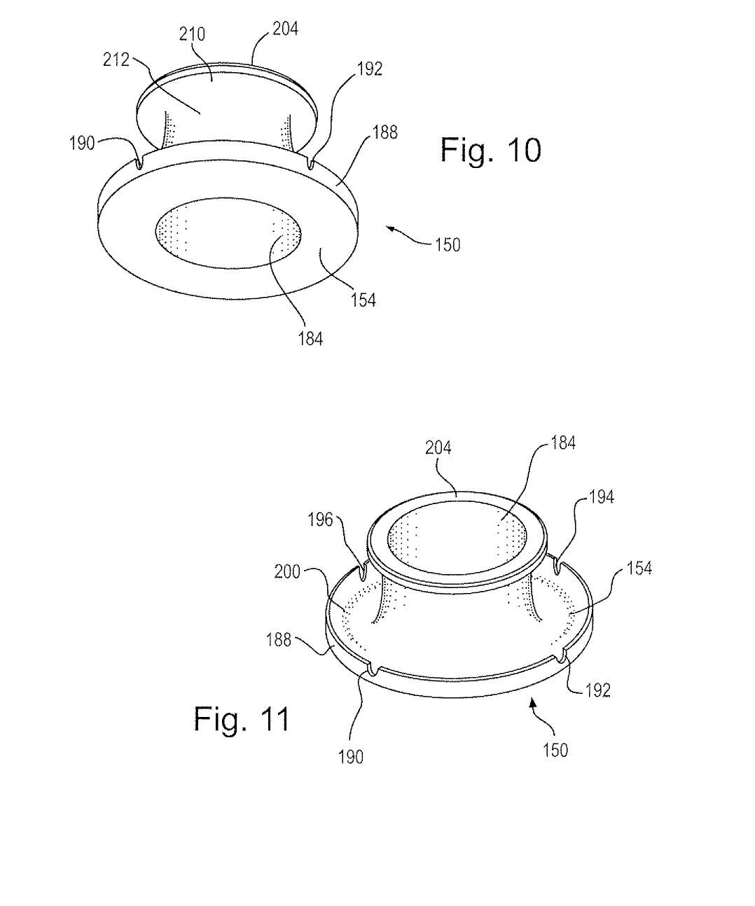

As seen in FIGS. 10 and 11, the reservoir 154 has a barrier 188 for directing the flow of liquid in the reservoir 154. The barrier 188 defines at least one opening. In a preferred embodiment, there are a number of openings defined by the barrier 188 and spaced equally about the barrier 188. In the embodiment shown in FIGS. 9 to 13, there are four openings 190, 192, 194 and 196. Each of the openings 190, 192, 194 and 196 is identically shaped and sized.

In a preferred embodiment, the reservoir 154 further defines a groove 200. The groove 200 is situated in the reservoir 154 below the openings 190, 192, 194 and 196 in the reservoir 154 and is in communication with the openings 190, 192, 194 and 196. The floor of the groove 200 is smooth and continuous.

A top surface 204 of the cylinder 180 is bevelled such that the circumference of the top surface 204 of the cylinder 180 is slightly less than the circumference of an aperture 208 defined by the cover 170. An outer surface 212 of the cylinder 180 immediately below the bevelled portion of the top surface 204 of the cylinder 180 has a circumference slightly larger than the circumference of the aperture 208 and as such, forms a lip 210.

As seen in FIG. 9, the cover 170 used in combination with the attachment 150 has two hose attachments 220 and 222 attached to the cover 170. The hose attachments 220 and 222 are each engaged with the cover 170 by being pressed through a separate hole 230 through a sheet 224. Hoses 226 and 228 are attached to the hose attachments 220 and 222. While the embodiment of the invention shown in FIG. 9 has two hoses and two hose attachments, it will be apparent to a person skilled in the art that the objects of the invention can be achieved if there is one or more hoses and one or more hose attachments.

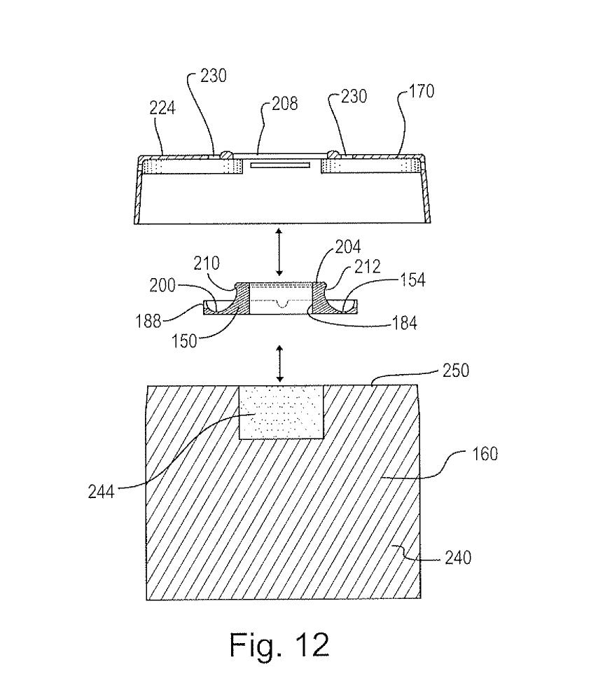

As indicated in FIG. 12, in operation, a user may engage the attachment 150 with the cover 170 by placing the lip 210 against the portion of the sheet 224 surrounding the aperture 208 on the side of the cover 170 that faces the surface of a plant growing medium and applying force to the attachment 150. The top surface 204 of the cylinder 180 will be forced through the aperture 208 and the lip 210 will engage the portion of the sheet 224 surrounding the aperture 208. In an alternative embodiment (not shown) the cylinder 180 is integrally attached to the cover 170.

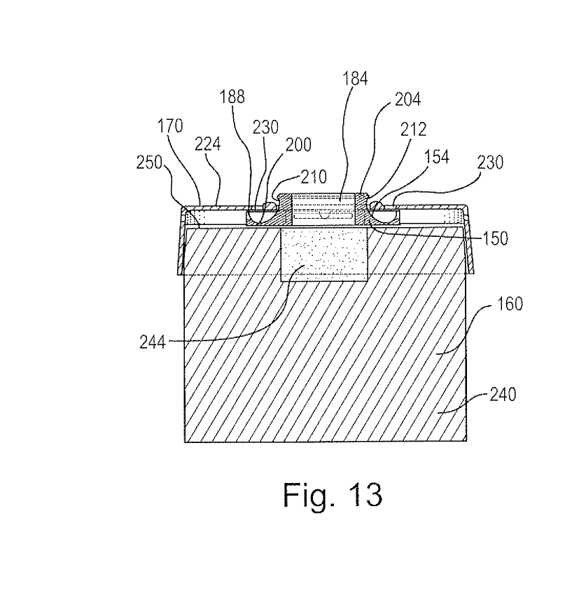

As seen in FIG. 13, once the attachment 150 is engaged with the cover 170, the cover 170 may be set upon a plant growing medium 240. The attachment is orientated such that a plant (not shown) may extend through the hollow 184 defined by the cylinder 180. When the attachment 150 is engaged with the cover 170 and the cover 170 is placed upon the plant growing medium 240, the floor of the groove 200 is parallel to the top surface 250 of the plant growing medium 240.

Liquid then flows into the reservoir 154 through the holes 230 defined by the cover 170. The holes are orientated above the reservoir 154 when the attachment 150 is engaged with the cover 170. In a preferred embodiment, liquid flows through the hoses 226 and 228 and hose attachments 220 and 222 into the reservoir 154.

Once the liquid enters the reservoir 154 it accumulates in the groove 200 defined by the reservoir 154 until the groove 200 is full of liquid. Once the groove 200 is full of liquid, the liquid escapes from the reservoir 154 through the openings 190, 192, 194 and 196 and drips onto the plant growing medium 240. In a preferred embodiment of the invention incorporating a uniform groove 200 and identically shaped and sized openings 190, 192, 194 and 196, liquid escapes from each opening at an equal rate and is thus delivered to separate areas of the top surface 250 of the plant growing medium 240 in a uniform manner.

A further embodiment of the invention is shown in FIG. 15. Specifically, FIG. 15 shows a hose attachment 260. The hose attachment 260 has an inlet end 264 and an outlet end 268. The hose attachment 260 has an outlet portion 270 proximate to the outlet end 268. The outlet portion 270 has an exterior wall 274 that is bevelled.

The hose attachment 260 has an inlet portion 276 proximate to the inlet end 264. The inlet portion 276 is separated from the outlet portion 270 by a flange 280. The portion of the outlet portion 270 proximate to the inlet portion 276 and the portion of the inlet portion 276 proximate to the outlet portion 270 are each slightly wider than the width of a hole in a cover. The width of the portion of the hose attachment 260 between the outlet portion 270 and the inlet portion 276 is less than the width of the hole.

The hose attachment 260 has an interior wall 284. The interior wall 284 defines a channel 288 through the hose attachment 260. The circumference of the interior wall 284 decreases in a manner such that the width of the channel 288 proximate to the inlet end 264 is greater than the width of the channel 288 proximate to the outlet end 268.

The hose attachment 260 has a plurality of threads 290 projecting from the interior wall 284 of the hose attachment 260. The circumference of a thread proximate to the inlet end 264 will be greater than the circumference of a thread proximate to the outlet end 268.

In operation, as seen in FIG. 9, the outlet end 268 of the hose attachment 260 is placed against the outside of the cover 170 that does not face the plant growing medium 240 and against the hole 230 in the cover 170. When pressure is applied against the hose attachment 260, the entire outlet portion 270 of the hose attachment 260 is pressed through the hole 230 and the flange 280 rests against the portion of the cover 170 surrounding the hole. Accordingly, the inlet portion 276 extends above the hole 230 and the outlet portion 270 extends below the hole 230.

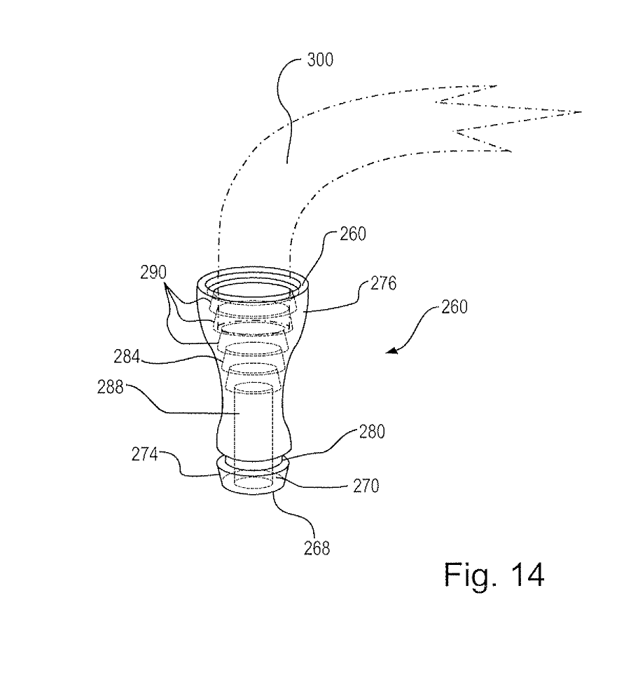

As seen in FIG. 14, either before or after the outlet portion 270 is pressed through the hole 230, a hose 300 is inserted into the inlet portion 276 of the hose attachment 260. Preferably the hose 300 is constructed from a malleable material such that when an end of the hose 300 engages a thread 290, slight downward pressure upon the hose 300 will force the end of the hose 300 beyond the thread 290 and further into the inlet portion 276 so as to releasably secure the hose 300 in the hose attachment 260. Liquid flowing through the hose 300 is deposited into the channel 288 and flows out of the outlet end 268 of the hose attachment 260 into a reservoir or onto a plant growing medium.

It will be apparent to those having ordinary skill in this art that various modifications and variations may be made to the embodiments disclosed herein, consistent with the present invention, without departing from the spirit and scope of the present invention. Other embodiments consistent with the present invention will become apparent from consideration of the specification and the practice of the invention disclosed herein. Accordingly, the specification and the embodiment are to be considered exemplary only, with a true scope and spirit of the invention being disclosed by the following claims.

I claim:

1. A device for covering a plant growing medium comprising:
a sheet;
an aperture defined by the sheet;
a first portion of the sheet surrounding the aperture;
a second portion of the sheet having at least one ledge engaging a top surface of the plant growing medium and integrated with the first portion of the sheet such that the at least one ledge is situated at a height below the height of the first portion of the sheet.

2. The device of claim 1 wherein the first portion of the sheet is substantially planar.

3. The device of claim 2 wherein the sheet has four edges and a ledge situated at each intersection of two edges.

4. The device of claim 3 wherein a surface of each of the ledges is parallel to the plane of the sheet.

5. The device of claim 1 further comprising four walls wherein each wall is attachable to the sheet and engages the plant growing medium.

6. The device of claim 5 wherein each of the walls define a slit situated at a height above the height of the at least one ledge.

7. The device of claim 5 wherein there are two sets of opposing walls.

8. The device of claim 7 wherein the device has two portions that may be placed laterally upon the plant growing medium about a plant engaged with the plant growing medium.

9. The device of claim 8 wherein the two portions are pivotally attachable to one another.

10. The device of claim 1 wherein the first portion of the sheet surrounding the aperture is removably attachable to the second portion of the sheet which surrounds the first portion of the sheet.

11. A device for use with a cover for a plant growing medium, the cover defining an aperture, the device comprising:
a reservoir for receiving liquid through at least one hole defined by the cover;
a means for suspending the reservoir above the plant growing medium and below the cover; and
at least one opening defined by the reservoir wherein the at least opening is in communication with the plant growing medium.

12. The device of claim 11 wherein the means for suspending the reservoir above the plant growing medium is a cylinder attachable to the reservoir.

13. The device of claim 12 wherein the cylinder engages the cover and the plant growing medium.

14. The device of claim 13 wherein a hollow defined by a wall of the cylinder is in communication with the aperture defined by the cover.

15. The device of claim 14 wherein a top surface of the cylinder is bevelled and the cylinder has a lip proximate to the top surface of the cylinder that engages a portion of the cover surrounding the aperture.

16. The device of claim 12 wherein the reservoir is integrally attached to the cylinder.

17. The device of claim 11 wherein the reservoir further defines a groove situated below the at least one opening and in communication with the at least one opening.

18. The device of claim 11 wherein there are four openings equally spaced about a border of the reservoir and each of the openings is in communication with the plant growing medium.

19. A device for covering a plant growing medium comprising:
a sheet;
an aperture defined by the sheet;
a reservoir for receiving water through at least one hole defined by the sheet, the reservoir attachable to the sheet such that the reservoir is suspended above the plant growing medium and below the sheet; and
at least one opening defined by the reservoir wherein the at least opening is in communication with the plant growing medium.

20. The device of claim 19 further comprising at least one ledge for engaging a top surface of the plant growing medium and attached to the sheet such that the at least one ledge is situated at a height below the height of the sheet.

21. The device of claim 20 wherein the reservoir is attachable to a cylinder engaged with the sheet.

22. The device of claim 21 wherein a hollow defined by a wall of the cylinder is in communication with the aperture defined by the sheet.

23. The device of claim 19 wherein the reservoir further defines a groove situated below the at least one opening and in communication with the at least one opening.

24. The device of claim 19 wherein there are four openings equally spaced about a border of the reservoir and each of the openings is in communication with the plant growing medium.

25. A device for engaging a hole in a cover for a plant growing medium, the device comprising:
an outlet portion for discharging water, the outlet portion having a bevelled exterior wall such that the outlet portion may be received by the hole;
an inlet portion for receiving water from a hose inserted into the inlet portion wherein the inlet portion is separated from the outlet portion by a flange at an end of outlet portion proximate to the inlet portion and the flange engages a portion of the cover surrounding the hole;
an interior wall defining a channel through the device whereby the interior wall slopes such that the channel is wider at an end of the inlet portion distal from the outlet portion than at an end of the inlet portion proximate to the outlet portion; and
a plurality of threads projecting from the interior wall of the device such that one of the threads releasably secures the hose inserted into the inlet portion.
